(19) United States
(12) Patent Application Publication
(10) Pub. No.: US 2022/0126508 A1
(43) Pub. Date: Apr. 28, 2022

(54) PRINT HEAD FOR ADDITIVE MANUFACTURING SYSTEM

(71) Applicant: Continuous Composites Inc., Coeur d'Alene, ID (US)

(72) Inventors: Brock Adam Jahner, Coeur d'Alene, ID (US); Nathan Andrew Stranberg, Post Falls, ID (US); Andrew John Overby, Coeur d'Alene, ID (US); Ryan C. Stockett, Spokane, WA (US)

(73) Assignee: Continuous Composites Inc., Coeur d'Alene, ID (US)

(21) Appl. No.: 17/446,596

(22) Filed: Aug. 31, 2021

Related U.S. Application Data
(60) Provisional application No. 63/104,929, filed on Oct. 23, 2020.

(51) Int. Cl. B29C 64/165; B33Y 10/00; B33Y 30/00

(52) U.S. Cl. CPC B29C 64/165; B33Y 50/02; B33Y 30/00; B33Y 10/00

(57) ABSTRACT

A method is disclosed for additively manufacturing a composite structure. The method may include discharging a composite material to form a first layer having a first void, and discharging the composite material adjacent the first layer to form a second layer having a second void. The method may further include discharging a material into the first and second voids to lock the first and second layers together.

### RELATED APPLICATION

This application is based on and claims the benefit of priority from U.S. Provisional Application No. 63/104,929 that was filed on Oct. 23, 2020, the contents of which are expressly incorporated herein by reference.

### TECHNICAL FIELD

The present disclosure relates generally to a manufacturing system and, more particularly, to a print head and method for additively manufacturing a composite structure.

### BACKGROUND

Continuous fiber 3D printing (a.k.a., CF3D®) involves the use of continuous fibers embedded within material discharging from a moveable print head. A matrix is supplied to the print head and discharged (e.g., extruded and/or pultruded) along with one or more continuous fibers also passing through the same head at the same time. The matrix can be a traditional thermoplastic, a liquid thermoset (e.g., an energy-curable single- or multi-part resin), or a combination of any of these and other known matrixes. Upon exiting the print head, a cure enhancer (e.g., a UV light, a laser, an ultrasonic emitter, a heat source, a catalyst supply, etc.) is activated to initiate, enhance, and/or complete curing of the matrix. This curing occurs almost immediately, allowing for unsupported structures to be fabricated in free space. And when fibers, particularly continuous fibers, are embedded within the structure, a strength of the structure may be multiplied beyond the matrix-dependent strength. An example of this technology is disclosed in U.S. Pat. No. 9,511,543 that issued to TYLER on Dec. 6, 2016.

Although continuous fiber 3D printing provides for increased strength, compared to manufacturing processes that do not utilize continuous fiber reinforcement, care must be taken to ensure proper wetting of the fibers with the matrix, proper cutting of the fibers, automated restarting after cutting, proper compaction of the matrix-coated fibers after discharge, and proper curing of the compacted material. An exemplary print head that provides for at least some of these functions is disclosed in U.S. Patent Application Publication 2020/0315057 that published on Oct. 17, 2020 (“the '057 publication”).

While the print head of the '057 publication may be functionally adequate for many applications, it may be less than optimal. For example, structures fabricated with the print head may still have an interlaminar shear strength that is too low for some applications. The disclosed print head and method are directed at addressing one or more of these issues and/or other problems of the prior art.

### SUMMARY

In one aspect, the present disclosure is directed to a method for additively manufacturing a composite structure. The method may include discharging a composite material to form a first layer having a first void, and discharging the composite material adjacent the first layer to form a second layer having a second void. The method may further include discharging a material into the first and second voids to lock the first and second layers together.

In another aspect, the present disclosure is directed to another method for additively manufacturing a composite structure. This method may include discharging a composite material to form a first layer having a first void, and discharging the composite material adjacent the first layer to form a second layer having a second void. The method may also include at least partially hardening at least one of the first or second layers, and discharging a material into the first and second voids after at least partially hardening to lock the first and second layers together

In yet another aspect, the present disclosure is directed to a system for additively manufacturing a composite structure. The system may include a support, at least one print head operatively connected to and moveable by the support, and a controller in communication with the support and the at least one print head. The controller may be programmed to cause the at least one print head to discharge a composite material to form a first layer having a first void, and cause the at least one print head to discharge the composite material adjacent the first layer to form a second layer having a second void. The controller may also be programmed to cause the at least one print head to discharge a material into the first and second voids to lock the first and second layers together.

### BRIEF DESCRIPTION OF THE DRAWINGS

FIG. 1 is a diagrammatic illustration of an exemplary disclosed manufacturing system; and

FIGS. 2 and 3 are diagrammatic illustrations of an exemplary disclosed process that may be implemented by the manufacturing system of FIG. 1.

### DETAILED DESCRIPTION

The term “about” as used herein serves to reasonably encompass or describe minor variations in numerical values measured by instrumental analysis or as a result of sample handling. Such minor variations may be in the order of plus or minus 0% to 10%, plus or minus 0% to 5%, or plus or minus 0% to 1%, of the numerical values.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more.

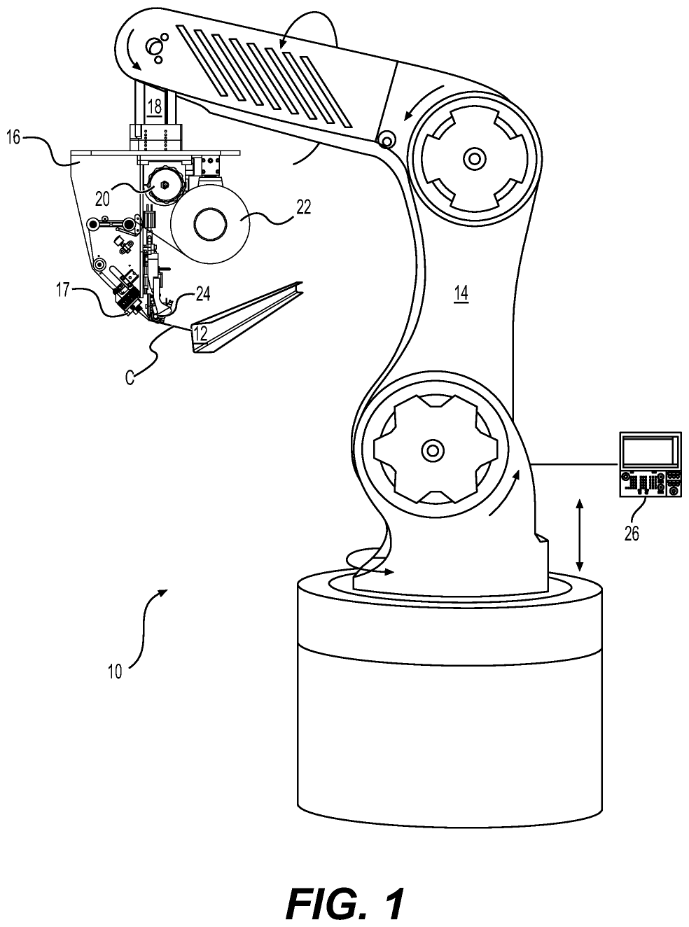

FIG. 1 illustrates an exemplary system 10, which may be used to manufacture a composite structure 12 having any desired shape, size, configuration, and/or material composition. System 10 may include at least a support 14 and a head 16. Head 16 may be coupled to and moveable by support 14 during discharge of a composite material (shown as C) through an outlet 17. In the disclosed embodiment of FIG. 1, support 14 is a robotic arm capable of moving head 16 in multiple directions during fabrication of structure 12. Support 14 may alternatively embody a gantry (e.g., an overhead-bridge gantry, a single-post gantry, etc.) or a hybrid gantry/arm also capable of moving head 16 in multiple directions during fabrication of structure 12. Although support 14 is shown as being capable of 6-axis movements, it is contemplated that any other type of support 14 capable of moving head 16 in the same or a different manner could also be utilized. In some embodiments, a drive or coupler 18 may mechanically join head 16 to support 14 and include components that cooperate to move portions of and/or supply power and/or materials to head 16.

Head 16 may be configured to receive or otherwise contain a matrix that, together with a continuous reinforcement, makes up the composite material discharging from head 16. The matrix may include any type of material that is curable (e.g., a liquid resin, such as a zero-volatile organic compound resin, a powdered metal, etc.). Exemplary resins include thermosets, single- or multi-part epoxy resins, polyester resins, cationic epoxies, acrylated epoxies, urethanes, esters, thermoplastics, photopolymers, polyepoxides, thiols, alkenes, thiol-enes, and more. In one embodiment, the matrix inside head 16 may be pressurized, for example by an external device (e.g., by an extruder or another type of pump—not shown) that is fluidly connected to head 16 via a corresponding conduit (not shown). In another embodiment, however, the pressure may be generated completely inside of head 16 by a similar type of device 20. In yet other embodiments, the matrix may be gravity-fed into and/or through head 16. For example, the matrix may be fed into head 16 and pushed or pulled out of head 16 along with one or more continuous reinforcements. In some instances, the matrix inside head 16 may benefit from being kept cool and/or dark (e.g., to inhibit premature curing or otherwise obtain a desired rate of curing after discharge). In other instances, the matrix may need to be kept warm for similar reasons. In either situation, head 16 may be specially configured (e.g., insulated, temperature-controlled, shielded, etc.) to provide for these needs.

The matrix may be used to coat any number of continuous reinforcements (e.g., separate fibers, tows, rovings, ribbons, socks, sheets and/or tapes of continuous material) at or upstream of outlet 17 and, together with the reinforcements, make up a portion (e.g., a wall) of composite structure 12. The reinforcements may be stored within (e.g., on one or more separate internal creels 22) or otherwise passed through outlet 17 of head 16 (e.g., fed from one or more external spools—not shown). When multiple reinforcements are simultaneously used (e.g., interwoven, one on top of another, adjacent tracks, etc. that are combined prior to and/or after entering head 16), the reinforcements may be of the same material composition and have the same sizing and cross-sectional shape (e.g., circular, square, rectangular, etc.), or a different material composition with different sizing and/or cross-sectional shapes. The reinforcements may include, for example, carbon fibers, vegetable fibers, wood fibers, mineral fibers, glass fibers, metallic wires, optical tubes, etc. It should be noted that the term “reinforcement” is meant to encompass both structural and non-structural types of continuous materials that are at least partially encased in the matrix discharging from head 16.

The reinforcements may be exposed to (e.g., at least partially coated with) the matrix while the reinforcements are inside head 16, while the reinforcements are being passed to head 16, and/or while the reinforcements are discharging through outlet 17. The matrix, dry reinforcements, and/or reinforcements that are already exposed to the matrix (e.g., pre-impregnated reinforcements) may be transported into head 16 in any manner apparent to one skilled in the art. In some embodiments, a filler material (e.g., chopped fibers) may be mixed with the matrix before and/or after the matrix coats the continuous reinforcements. It is also contemplated that the filler material and the matrix may selectively be utilized alone, without continuous reinforcements, in some applications.

As will be explained in more detail below, one or more cure enhancers (e.g., a UV light, an ultrasonic emitter, a laser, a heater, a catalyst dispenser, etc.) 24 may be mounted proximate (e.g., within, on, or adjacent) outlet 17 and configured to enhance a cure rate and/or quality of the matrix as it discharges from head 16. The cure enhancer(s) may be controlled to selectively expose portions of structure 12 to energy (e.g., to UV light, electromagnetic radiation, vibrations, heat, a chemical catalyst, etc.) during material discharge and the formation of structure 12. The energy may trigger a chemical reaction to occur within the matrix, increase a rate of the chemical reaction, sinter the matrix, harden the matrix, or otherwise cause the matrix to cure as it discharges from head 16. The amount of energy produced by the cure enhancer(s) may be sufficient to cure the matrix before structure 12 axially grows more than a predetermined length away from head 16. In one embodiment, structure 12 is cured before the axial growth length becomes equal to an external diameter of the matrix-coated reinforcement.

The matrix and/or reinforcement may be discharged from head 16 via one or more different modes of operation. In a first exemplary mode of operation, the matrix and/or reinforcement are extruded (e.g., pushed under pressure and/or mechanical force) from head 16 as head 16 is moved by support 14 to create the 3-dimensional trajectory within a longitudinal axis of the discharging material. In a second exemplary mode of operation, at least the reinforcement is pulled from head 16, such that a tensile stress is created in the reinforcement during discharge. In this mode of operation, the matrix may cling to the reinforcement and thereby also be pulled from head 16 along with the reinforcement, and/or the matrix may be discharged from head 16 under pressure along with the pulled reinforcement. In the second mode of operation, where the matrix is being pulled from head 16 with the reinforcement, the resulting tension in the reinforcement may increase a strength of structure 12 (e.g., by aligning the reinforcements, inhibiting buckling, etc.), while also allowing for a greater length of unsupported structure 12 to have a straighter trajectory. That is, the tension in the reinforcement remaining after curing of the matrix may act against the force of gravity (e.g., directly and/or indirectly by creating moments that oppose gravity) to provide support for structure 12.

The reinforcement may be pulled from head 16 as a result of head 16 being moved by support 14 away from an anchor (e.g., a print bed, a table, a floor, a wall, a surface of structure 12, etc.—not shown). In particular, at the start of structure formation, a length of matrix-impregnated reinforcement may be pulled and/or pushed from head 16, deposited onto the anchor, and at least partially cured, such that the discharged material adheres (or is otherwise coupled) to the anchor. Thereafter, head 16 may be moved away from the anchor (e.g., via controlled regulation of support 14), and the relative movement may cause the reinforcement to be pulled from head 16. It should be noted that the movement of reinforcement through head 16 could be assisted (e.g., via one or more internal feed mechanisms), if desired. However, the discharge rate of reinforcement from head 16 may primarily be the result of relative movement between head 16 and the anchor, such that tension is created within the reinforcement. It is contemplated that the anchor could be moved away from head 16 instead of or in addition to head 16 being moved away from the anchor.

A controller 26 may be provided and communicatively coupled with support 14, head 16, and any number of the cure enhancer(s). Each controller 26 may embody a single processor or multiple processors that are specially programmed or otherwise configured to control an operation of system 10. Controller 26 may further include or be associated with a memory for storing data such as, for example, design limits, performance characteristics, operational instructions, tool paths, and corresponding parameters of each component of system 10. Various other known circuits may be associated with controller 26, including power supply circuitry, signal-conditioning circuitry, solenoid driver circuitry, communication circuitry, and other appropriate circuitry. Moreover, controller 26 may be capable of communicating with other components of system 10 via wired and/or wireless transmission.

One or more maps may be stored in the memory of controller 26 and used by controller 26 during fabrication of structure 12. Each of these maps may include a collection of data in the form of lookup tables, graphs, and/or equations. In the disclosed embodiment, controller 26 may be specially programmed to reference the maps and determine movements of head 16 required to produce the desired size, shape, and/or contour of structure 12, and to responsively coordinate operation of support 14, device 20, creel 22, cure enhancer(s) 24, and other components of head 16.

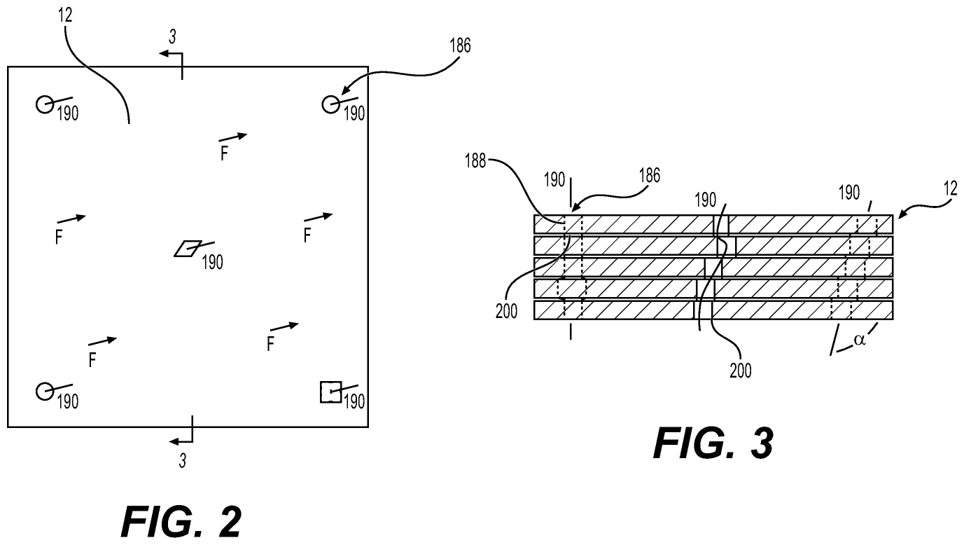

FIGS. 2 and 3 illustrate an exemplary structure 12 that may be fabricated by system 10 during implementation of an exemplary process by controller 26. FIGS. 2 and 3 will be discussed in more detail below to further illustrate the disclosed concepts.

### INDUSTRIAL APPLICABILITY

The disclosed system and print head may be used to manufacture composite structures having any desired cross-sectional size, shape, length, density, and/or strength. The composite structures may include any number of different reinforcements of the same or different types, diameters, shapes, configurations, and consists, each coated with a common matrix. Operation of system 10 will now be described in detail with reference to FIGS. 2 and 3.

At a start of a manufacturing event, information regarding a desired structure 12 may be loaded into system 10 (e.g., into controller 26 that is responsible for regulating operations of support 14 and/or head 16). This information may include, among other things, a size (e.g., diameter, wall thickness, length, etc.), a shape, a contour (e.g., a trajectory), surface features (e.g., ridge size, location, thickness, length; flange size, location, thickness, length; etc.) and finishes, connection geometry (e.g., locations and sizes of couplers, tees, splices, etc.), location-specific matrix stipulations, location-specific reinforcement stipulations, compaction requirements, curing requirements, etc. It should be noted that this information may alternatively or additionally be loaded into system 10 at different times and/or continuously during the manufacturing event, if desired.

Based on the component information, one or more different reinforcements and/or matrixes may be selectively loaded into head 16. For example, one or more supplies of matrix may be loaded into device 20 and one or more reinforcements may be loaded onto creel 22 (referring to FIG. 1). The reinforcements may then be threaded through head 16 prior to start of the manufacturing event. This may include, for example, wetting the reinforcement pulled from creel 22 with matrix supplied by device 20, and passing the matrix-wetted reinforcement through outlet 17. After threading is complete, head 16 may be ready to discharge the matrix-coated reinforcements.

At a start of a discharging event, cure source(s) 24 may be activated to anchor the matrix wetted reinforcement. Head 16 may thereafter be moved away from the anchor to cause the reinforcement to be pulled out of head 16 and at least partially cured. This discharge may continue until discharge is complete and/or until head 16 must move to another location of discharge without discharging material during the move.

The component information may be used to control operation of system 10. For example, the reinforcements may be discharged from head 16 (along with the matrix), while support 14 selectively moves head 16 in a desired manner during curing, such that an axis of the resulting structure 12 follows a desired trajectory.

In one example, the desired trajectory of head 16 during material discharge may produce a path that is at least partially cured (e.g., hardened sufficient to hold its shape). As multiple paths are formed adjacent each other, a layer of structure 12 may be fabricated. It should be noted that each layer may lie within a common plane and for a two-dimensional surface. Alternatively or additionally, the paths may deviate from the plan to form a three-dimensional surface that has a thickness at each location that is about equal to a thickness of the path. In some applications, multiple layers may be fabricated to overlap each other, thereby increasing a thickness of structure 12 at the overlap areas.

It has been found that, because each path and each layer of discharged material is at least partially cured during discharge, an adhesion between layers may weaker than an adhesion within a given layer. That is, an interlaminar strength of structure 12, if not otherwise accounted for, may be less than desired.

In some applications, it may be desirable to improve the interlaminar sheer strength between adjacent layers of discharged material within structure 12. As shown in FIGS. 2 and 3, one way to do this may be to fabricate one or more interlocking features 186 that extend between and thereby lock together the adjacent layers. These features 186 may include, for example, voids (e.g., holes, slots, channels, grooves, etc.) 188 within each layer that are generally aligned with each other and projections 200 that pass through voids 188 and bind to the surrounding material of each layer.

In one embodiment, voids 188 may be fabricated in situ during normal fabrication of each layer of structure 12. For example, controller 26 may be programmed to cause support 14 to steer the reinforcements discharging from head 16 around a desired void location, thereby forming a section of void 188 within each layer. It should be noted that an axis or centerline 190 of the columnar voids 188 formed by the aligned sections of all of the layers may be oriented generally normal (i.e., orthogonal) to the surface of each layer in some embodiments. In these embodiment, each of the sections of void 188 may be placed directly over each other such that their individual axes align to form axis 190 (see left-most axis 190 in FIG. 3).

It is contemplated, however, that axis 190 may alternatively be tilted at an oblique angle α relative to the surface in other applications (see right-most axis 190 of FIG. 3). For example, the tilt angle could be intentionally aligned with a force vector F anticipated to pass through structure 12 (See FIG. 2) during usage and/or operation of structure 12, thereby increasing a resistance to interlaminar separation caused by loading. In these applications, a magnitude of the angle α may be a function of the force vector magnitude (e.g., a larger force vector may correspond with greater tilting).

The force vector(s) discussed above may be generated via application of the anticipated loading, boundary conditions and material properties within a simple FEA environment. High accuracy in this modeling may not be important, as a general vector field may be all that is required. It is contemplated that this field generation may be performed during modeling of structure 12 and preparation of pathing commands (i.e., before a corresponding part program is communicated to controller 26). Alternatively, the field generation may be performed by system 10 at a time of fabrication as a generic process applied to any part programs received by controller 26. For example, for a given part program, controller 26 may determine a number of features 186 to be formed at uniform spacing within primary surfaces of structure 12.

In the tilted-axis embodiment, the tilt angle α may be formed by incrementally offsetting between layers the sections that make up void 188. For example, each section of void 188 may be offset within each layer from an adjacent section by a predetermined amount (i.e., an amount related to a thickness of the layer) that provides for the tilt of the overall axis 190 passing through a center of all sections. That is, even though individual axes of each of the sections may still be generally orthogonal to the surface at each layer, axis 190 may pass through a lengthwise-center of each of the individual axes and still be oriented generally at the tilt angle α.

It is contemplated that axis or centerline 190 could be curvilinear, if desired. That is, each section of void 188 within each layer of structure 12 could be offset a different amount (see middle axis 190 of FIG. 3). This variable offset may provide different characteristics to different layers, for example greater stiffness between some layers and greater flexibility between other layers.

Another way to adjust the characteristics of individual layers may be to adjust a shape and/or a size of the sections that make up void 188. For example, although shown as having a generally circular cross-sectional shape, each section of each layer could have a different shape (e.g., triangular, diamond, elliptical, rectangular, teardrop, etc. —see FIG. 2). In addition, features (e.g., vertices) of these shapes may be oriented to align with (or intentionally misalign with) the tilting of axis 190 and the force vectors discussed above. Further, the cross-sectional area of each section could be large or smaller than an adjacent area (see left-most void 188 of FIG. 3), providing a variable level of stiffness, adhesion, etc.

It is contemplated that void formation could be accomplished after structure 12 is otherwise complete, if desired. For example, voids 188 may be fabricated via subtractive machining (e.g., drilling, reaming, ablation, laser or chemical etching, water-jetting, etc.). This formation may be accomplished via system 10 (e.g., via tool changing with a machining tool in place of head 16) or a different system, as desired.

Projections 200 may be fabricated after some or all layers of structure 12 have been fabricated. For example, after a threshold number of layers of structure 12 have been discharged, compacted and/or cured, a material of projections 200 may be discharged through the aligned sections of voids 188. The threshold number of layers may be associated with a maximum penetration depth of cure energy through voids 188, a maximum layer thickness associated with a self-supporting strength requirement of structure 12, or another limitation of system 10 and/or structure 12. In one example, the material used to fabricate projections 200 includes matrix coated reinforcements (e.g., chopped reinforcements and/or particles). The matrix may be the same matrix used to fabricate the layers of structure 12 or a different matrix. Similarly, the reinforcements may be the same reinforcements used to fabricate the layers of structure 12 or different reinforcements. The material of projections 200 may be discharged by head 16 or another print head of system 10 that is connectable to support 14 or another support. The matrix may be curable (e.g., as a thermoset via exposure to a cure energy) and/or hardened via cooling (e.g., as a thermoplastic), as desired. Once projections 200 are cured or otherwise hardened, the associated layers of structure 12 may be mechanically and chemically locked together.

In one embodiment, projections 200 may be fabricated in sections during formation of each layer of structure 12. For example, as controller 26 causes support 14 to steer head 16 around and thereby form voids 188, controller 26 may simultaneously cause 16 to increase a ratio of matrix-to-reinforcement discharged at the void locations. Thereafter, the excess matrix may naturally flow or be pressed by head 16 into the empty sections within each layer, thereby generating projections 200 one section at a time.

In yet another embodiment, projections 200 may be generated using pre-fabricated inserts. For example, before or after filling voids 188 with matrix, an insert (e.g., a stiffened segment of reinforcement) may be pushed into voids 188 (e.g., manually or automatically via a specialized print head). When voids 188 are first filled with matrix, the inserts may displace excess matrix from voids 188 and then be sealed within voids 188 by the remaining matrix. When the inserts are placed first into voids 188, additional matrix may thereafter be placed into voids 188 around the inserts by head 16 (or another head). In either embodiment, it is contemplated that the matrix of projections 200 may be a single- or multi-part epoxy that has already been activated, such that cure energy does not need to penetrate through the axial lengths of voids 188 to trigger cross-linking.

It will be apparent to those skilled in the art that various modifications and variations can be made to the disclosed system and head. Other embodiments will be apparent to those skilled in the art from consideration of the specification and practice of the disclosed system and head. It is intended that the specification and examples be considered as exemplary only, with a true scope being indicated by the following claims and their equivalents.

What is claimed is:

1. A method of additively manufacturing a composite structure, comprising:
discharging a composite material to form a first layer having a first void;
discharging the composite material adjacent the first layer to form a second layer having a second void; and
discharging a material into the first and second voids to lock the first and second layers together.

2. The method of claim 1, wherein the composite material includes a continuous reinforcement coated in a matrix.

3. The method of claim 2, wherein discharging the composite material to form the first layer having the first void includes steering the continuous reinforcement around an area of the first void.

4. The method of claim 2, wherein the material includes the matrix and is free of the continuous reinforcement.

5. The method of claim 4, wherein the material further includes at least one of chopped fibers and particles of fibers.

6. The method of claim 1, further including at least partially overlapping the first void with the second void.

7. The method of claim 6, further including aligning an axis of the second void with an axis of the first void.

8. The method of claim 6, wherein the first void has at least one of a shape or a cross-sectional area that is different than as a shape or a cross-sectional area of the second void.

9. The method of claim 6, wherein the material discharged into the first and second voids forms a columnar feature having an axis.

10. The method of claim 9, wherein the axis of the columnar feature is tilted at an oblique angle relative to a surface of at least one of the first or second layers at the first and second voids.

11. The method of claim 10, further including estimating a force that will pass through the composite structure during usage of the composite structure, wherein at least partially overlapping the first void with the second void includes at least partially overlapping the first void with the second void such that a tilt of the axis is aligned with the force.

12. The method of claim 9, wherein the axis is linear.

13. The method of claim 9, wherein the axis is curvilinear.

14. The method of claim 1, wherein:
the material includes a matrix; and
the method further includes placing a prefabricated insert into the first and second voids.

15. The method of claim 14, wherein placing the prefabricated insert into the first and second voids includes displacing at least some of the matrix from the first and second voids.

16. The method of claim 14, wherein discharging the material into the first and second voids includes discharging the matrix into the first and second voids around the prefabricated insert.

17. The method of claim 1, further including causing at least one of the first and second layers to harden before discharging the material.

18. A method of additively manufacturing a composite structure, comprising:
discharging a composite material to form a first layer having a first void;
discharging the composite material adjacent the first layer to form a second layer having a second void;
at least partially hardening at least one of the first or second layers; and
discharging a material into the first and second voids after at least partially hardening to lock the first and second layers together.

19. A system for additively manufacturing a composite structure, comprising:
a support;
at least one print head operatively connected to and moveable by the support; and
a controller in communication with the support and the at least one print head, the controller being configured to:
cause the at least one print head to discharge a composite material to form a first layer having a first void;
cause the at least one print head to discharge the composite material adjacent the first layer to form a second layer having a second void; and
cause the at least one print head to discharge a material into the first and second voids to lock the first and second layers together.

20. The additive manufacturing system of claim 19, wherein:
the material discharged into the first and second voids forms a columnar feature having a linear axis; and
the method further includes:
estimating a force that will pass through the composite structure during usage of the composite structure; and
at least partially overlapping the first void with the second void such that a tilt of the linear axis is aligned with the force.
